(19) United States
(12) Patent Application Publication
(10) Pub. No.: US 2015/0234041 A1
(43) Pub. Date: Aug. 20, 2015

(54) RADAR APPARATUS

(71) Applicant: FUJITSU TEN LIMITED, Hyogo (JP)

(72) Inventors: Masatoshi AOKI, Kobe-shi (JP); Yasuhiro KURONO, Kobe-shi (JP)

(21) Appl. No.: 14/597,815

(22) Filed: Jan. 15, 2015

(30) Foreign Application Priority Data
Feb. 20, 2014 (JP) 2014-030121

(51) Int. Cl. G01S 13/42; B60W 30/16; B60W 30/08

(52) U.S. Cl. CPC G01S 13/42; B60W 30/08; B60W 30/16

(57) ABSTRACT

A radar apparatus pairs an angle peak of an up section in which a frequency of a transmission signal increases and an angle peak of a down section in which the frequency of the transmission signal decreases based on a reliability of a pair. The radar apparatus derives a first index that shows a highest level of the reliability of a pair in a plurality of pairs of the angle peaks and a second index that shows another level of the reliability of another pair, the second index being lower than the first index in the reliability but being higher than other indexes excluding the first index, and also determines a validity of the pair having the highest level of the reliability based on a comparison result between the first index and the second index.

### BACKGROUND OF THE INVENTION

1. Field of the Invention

The invention relates to a signal processing on a radar apparatus.

2. Description of the Background Art

In general a radar apparatus detects a target existing in the periphery of a vehicle. The information on the detected target (hereinafter, referred to as “target information”) is output to a vehicle controller for use in various systems such as a vehicle control system that controls a vehicle to follow a preceding vehicle, and a vehicle control system that prevents collision between the vehicle and an obstacle.

The radar apparatus outputs a transmission wave based on a transmission signal, and receives a reflection wave that has been reflected by the preceding vehicle or the like. The radar apparatus performs Fast Fourier Transform (FFT) to a beat signal generated from the transmission signal and a reception signal generated based on the reflection wave, and extracts a peak exceeding a prescribed signal level. The radar apparatus obtains target information by pairing a peak in an up section in which the frequency of the transmission signal increases and a peak in a down section in which the frequency thereof decreases, and outputs the obtained target information to the vehicle controller. As the method of determining an optimum pair in the pairing processing, a method by calculating a Mahalanobis distance is well known.

However, the method of determining an optimum pair by calculating a Mahalanobis distance may determine as pair data an erroneous pair of a peak in the up section and a peak in the down section paired. That is, even in the case where the peak in the up section and the peak in the down section correspond to respectively different reflection points, the pair of the two peaks may be determined as long as the parameters of the peaks such as the angles thereof and the signal power thereof are approximated. In an example, the peaks corresponding to the different reflection points of a guardrail placed along a road may be determined as pair data erroneously.

In the case where the guardrail is detected as a target, the pair data of a right pair is determined as the pair data of a static object. However, the pair data of an erroneous pair (hereinafter, referred to as “erroneous pair data”) may be determined as the pair data of a moving object due to the frequency difference between the peak of the up section and the peak of the down section. The vehicle control system cannot perform appropriate vehicle control by use of the target information of the erroneous pair data.

### SUMMARY OF THE INVENTION

According to one aspect of the invention, a radar apparatus that pairs an angle peak of an up section in which a frequency of a transmission signal increases and an angle peak of a down section in which the frequency of the transmission signal decreases based on a reliability of a pair, the radar apparatus including a signal processor configured to derive a first index that shows a highest level of the reliability of a pair in a plurality of pairs of the angle peaks and a second index that shows another level of the reliability of another pair of the angle peaks, the second index being lower than the first index in the reliability but being higher than other indexes excluding the first index; and determine a validity of the pair having the highest level of the reliability based on a comparison result between the first index and the second index.

The radar apparatus is able to determine the validity of a pair based on the comparison result of the reliability in the plurality of pairs, and to obtain target information of a right pair.

According to another aspect of the invention, the first index corresponds to a shortest Mahalanobis distance and the second index corresponds to a second-shortest Mahalanobis distance, and the signal processor determines that the validity is low in a case where a difference between the shortest Mahalanobis distance and the second-shortest Mahalanobis distance is equal to or below a prescribed value.

The radar apparatus is able to determine the validity of a pair based on the difference of the Mahalanobis distances in each of the plurality of pairs, and to obtain target information of a right pair.

Therefore, the object of the invention is to provide a technology for accurately determining a validity of pairing.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 shows a configuration of a vehicle control system.

FIG. 2 shows a configuration of a radar apparatus.

FIG. 3 shows relation between a transmission wave and a reflection wave.

FIG. 4A shows an example of a frequency spectrum in an up section.

FIG. 4B shows an example of a frequency spectrum in a down section.

FIG. 5 shows an example of an angle spectrum.

FIG. 6 shows an example of a pairing processing based on a Mahalanobis distance.

FIG. 7 shows an example of information on pair data stored in a memory.

FIG. 8 shows a flowchart of a target information acquisition processing.

FIG. 9 shows a flowchart of an erroneous pair determination processing.

### DESCRIPTION OF THE EMBODIMENTS

Hereinafter, some embodiments of the invention are described based on attached drawings.

### First Embodiment

### 1. System Block Diagram

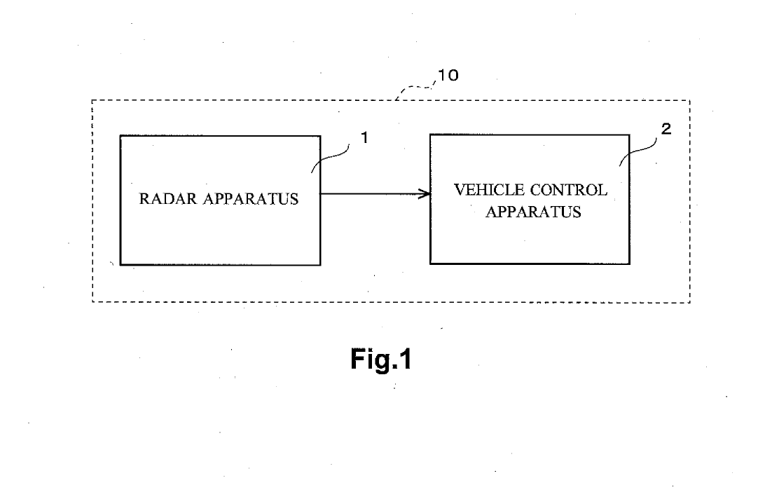

FIG. 1 shows a configuration of a vehicle control system 10. The vehicle control system 10 is installed in a vehicle such as a car. Hereinafter, the vehicle in which the vehicle control system 10 is installed is referred to as “own vehicle.” As shown in the figure, the vehicle control system 10 includes a radar apparatus 1 and a vehicle controller 2.

The radar apparatus 1 of the embodiment obtains the target information of a target existing in the periphery of the own vehicle by use of FM-CW (Frequency Modulated Continuous Wave). The radar apparatus 1 obtains the target information, for example, of a preceding vehicle existing in the front area of the own vehicle. The target information includes, for example, a longitudinal distance (m) that is a distance in which the reflection wave reflected by the target travels to a reception antenna of the radar apparatus 1, a relative velocity (km/h) of the target to the own vehicle, and a lateral distance (m) from the own vehicle to the target in the right and left direction (vehicle width direction). The radar apparatus 1 outputs the obtained target information to the vehicle controller 2.

The vehicle controller 2 is connected to a brake, a throttle and other devices of the own vehicle to control the behavior of the own vehicle based on the target information output by the radar apparatus 1. In an example, the vehicle controller 2 controls the own vehicle to follow a preceding vehicle, while keeping the distance constant between the own vehicle and the preceding vehicle. That is, the vehicle control system 10 of the embodiment functions as an ACC (Adaptive Cruise Control) system. The vehicle controller 2 controls the own vehicle to protect the passengers in the own vehicle in the case where there is a probability of collision between the own vehicle and the preceding vehicle. That is, the vehicle control system 10 of the embodiment functions as a PCS (Pre-Crash Safety System).

### 2. Radar Apparatus Block Diagram

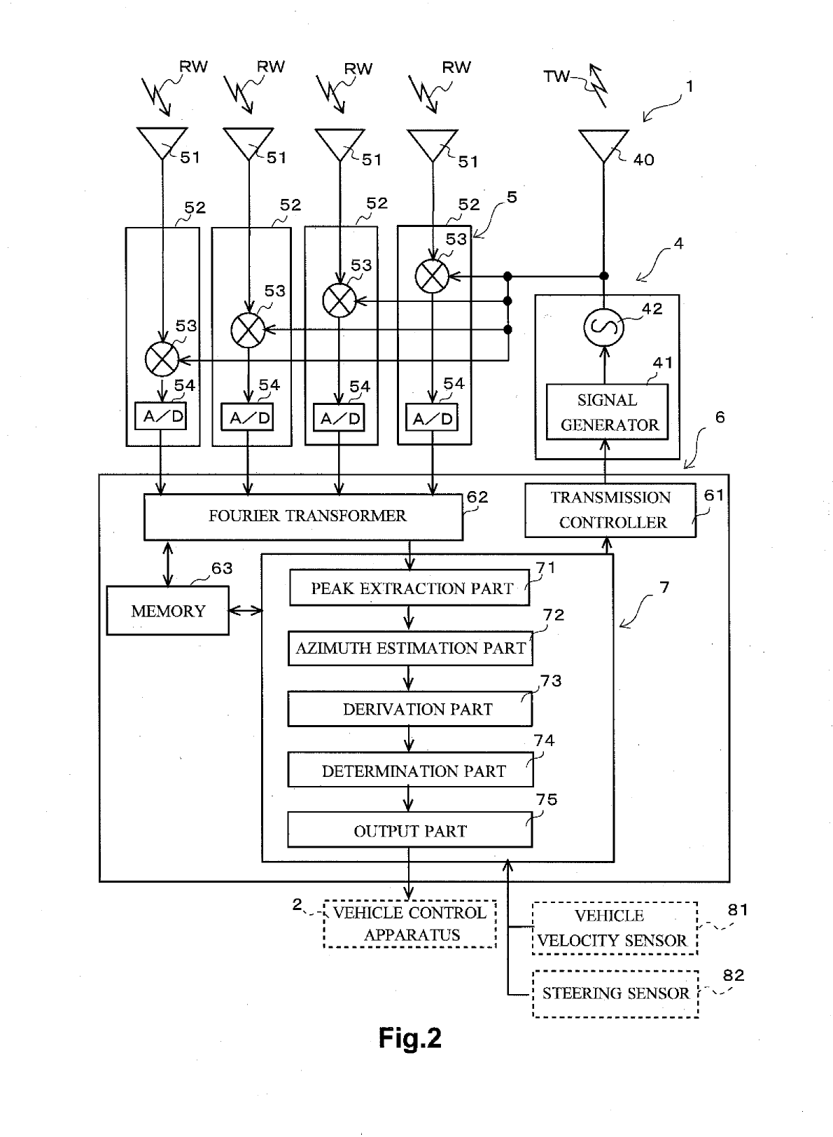

FIG. 2 shows a configuration of the radar apparatus 1. The radar apparatus 1 that is installed, for example, in the front bumper of the vehicle outputs a transmission wave outside the vehicle and receives a reflection wave reflected by a target. The radar apparatus 1 mainly includes a transmitter 4, a receiver 5 and a signal processing apparatus 6.

The transmitter 4 includes a signal generator 41 and an oscillator 42. The signal generator 41 generates a modulation signal whose voltage changes in a triangular wave form to output the generated signal to the oscillator 42. The oscillator 42 generates a transmission signal whose frequency changes as time elapses by performing frequency modulation to a continuous wave signal based on the modulation signal generated by the signal generator 41, so as to output the generated transmission signal to the transmission antenna 40.

The transmission antenna 40 outputs a transmission wave TW based on the transmission signal outside the own vehicle. The transmission wave TW output by the transmission antenna 40 changes in frequency in a predetermine cycle. The transmission wave TW transmitted to the front of the own vehicle by the transmission antenna 40 turns into a reflection wave RW when the transmission wave TW is reflected by a spot (reflection point) of the preceding vehicle.

The receiver 5 includes a plurality of reception antennas 51 forming an array antenna, and a plurality of individual receivers 52 each of which connects to each of the plurality of reception antennas 51. In the embodiment, the receiver 5 includes, for example, four of the reception antennas 51 and four of the individual receivers 52. Each of the four individual receivers 52 corresponds to each of the four reception antennas 51. Each of the reception antennas 51 receives the reflection wave RW reflected by the target. Each of the individual receivers 52 processes the reception signal received by the corresponding one of the reception antennas 51.

Each of the individual receivers 52 includes a mixer 53 and an A/D converter (analog-to-digital converter) 54. The reception signal obtained based on the reflection wave RW received by each of the reception antennas 51 is transmitted to the mixer 53 after being amplified by a low-noise amplifier (not shown in FIG. 2). The transmission signal is transmitted from the oscillator 42 of the transmitter 4 to the mixer 53, and the mixer 53 carries out mixing of the reception signal and the transmission signal. This generates a signal (hereinafter, referred to as “beat signal”) showing a frequency difference (hereinafter, referred to as “beat frequency”) between the frequency of the transmission signal and the frequency of the reception signal. The beat signal generated by the mixer 53 is output to the signal processing apparatus 6 after the A/D converter 54 converts from an analog beat signal to a digital beat signal.

The signal processing apparatus 6 includes a transmission controller 61, a Fourier transformer 62 and a data processor 7, which are the functions implemented by software in a microcomputer. The transmission controller 61 controls the signal generator 41 of the transmitter 4.

The Fourier transformer 62 performs Fast Fourier Transform (FFT) to the beat signal output by each of the plurality of individual receivers 52. Thereby, the Fourier transformer 62 transforms the beat signal relevant to the reception signal received by each of the plurality of the reception antennas 51 into a frequency spectrum that corresponds to frequency domain data. The frequency spectrum obtained by the Fourier transformer 62 is transmitted to the data processor 7.

The data processor 7 obtains the target information based on the frequency spectrum of each of the plurality of reception antennas 51. The data processor 7 outputs the obtained target information to the vehicle controller 2. The data processor 7 receives information from various sensors such as a vehicle velocity sensor 81 and a steering sensor 82 that are installed on the own vehicle. The data processor 7 can use, in the target information acquisition processing, a velocity of the own vehicle transmitted from the vehicle velocity sensor 81 and a steering angle of the own vehicle transmitted from the steering sensor 82.

### 3. Acquisition of Target Information

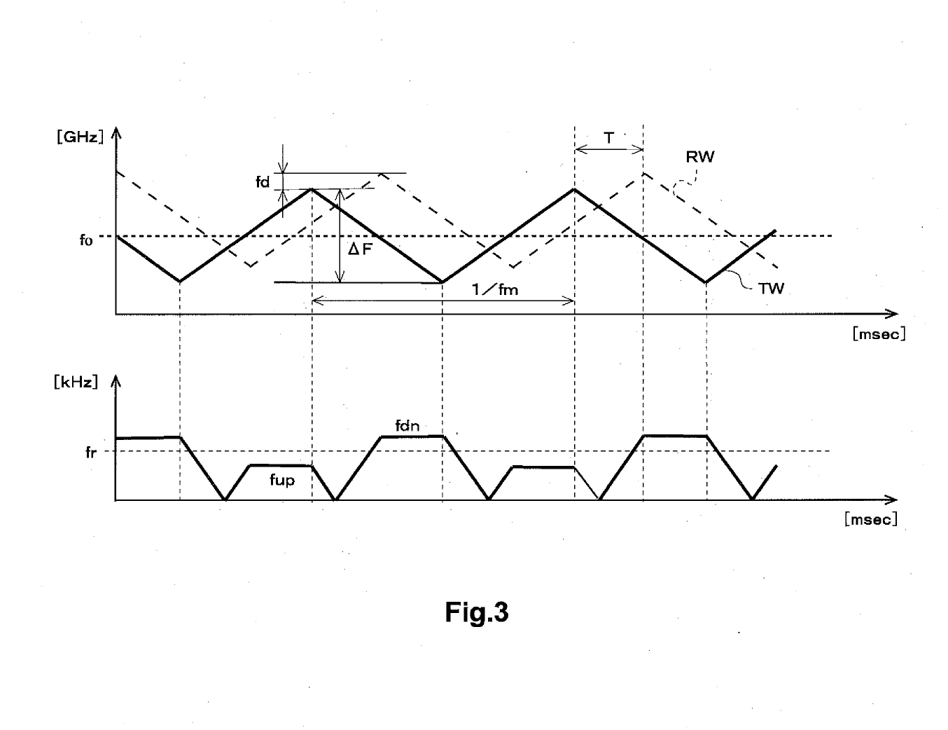

How the radar apparatus 1 obtains the target information is explained hereafter. FIG. 3 shows relation between the transmission wave TW and the reflection wave RW. For ease of explanation, it is assumed that the reflection wave RW shown in FIG. 3 is reflected by one ideal target. In FIG. 3, the transmission wave TW is shown with a solid line, and the reflection wave RW is shown with a broken line. In the upper figure of FIG. 3, the horizontal axis represents time [msec] and the vertical axis represents frequency [GHz].

As shown in FIG. 3, the transmission wave TW is a continuous wave that periodically changes in frequency up and down from a certain center frequency (e.g. 76.5 GHz). The frequency of the transmission wave TW changes linearly to time. Hereinafter, the section in which the frequency of the transmission wave TW increases is referred to as “up section,” while the section in which the frequency decreases is referred to as “down section.” In addition, the center frequency of the transmission wave TW is expressed by fo; the width of change in frequency of the transmission wave TW is expressed by ΔF; and the reciprocal of one up-down cycle of the frequency of the transmission wave TW is expressed by fm.

Since the transmission wave TW turns into the reflection wave RW when the transmission wave TW is reflected by a target, the reflection wave RW is also a continuous wave that periodically changes in frequency up and down from a certain center frequency, just like the transmission wave TW. However, the reflection wave RW is delayed by a time T behind the transmission wave TW. The time T that is delay time is relative to a longitudinal distance R of a target to the own vehicle, and is represented by the formula (1) below, by use of a light velocity (velocity of electric waves) c.

$$\begin{matrix}[ Numeral 1 ] & \\ T = \frac{2 \times R}{c} & ( 1 )\end{matrix}$$

A Doppler effect corresponding to a relative velocity V of a target to the own vehicle causes frequency shift by a frequency fd to the transmission wave TW.

As above, the reflection wave RW is delayed behind the transmission wave TW in accordance with a longitudinal distance, and the frequency thereof is shifted from the transmission wave TW in accordance with a relative velocity. Thus, as shown in the lower figure of FIG. 3, the beat signal generated by the mixer 53 changes in frequency between the up section and the down section. Hereinafter, the beat frequency in the up section is expressed by fup, while the beat frequency in the down section is expressed by fdn.

The beat frequency of the case where a relative velocity of the target is “0” (in the case of no frequency shift caused by the Doppler effect) is expressed by fr. The beat frequency fr is represented by the formula (2) below.

$$\begin{matrix}[ Numeral 2 ] & \\ fr = \frac{fup + fdn}{2} & ( 2 )\end{matrix}$$

The frequency fr is the value according to the above-described time T that is delay time. Thus, a longitudinal distance R of the target is calculated based on the formula (3) below, by use of the frequency fr.

$$\begin{matrix}[ Numeral 3 ] & \\ R = \frac{c}{4 \times Δ F \times fm} \times fr & ( 3 )\end{matrix}$$

A frequency fd by which a frequency is shifted due to the Doppler effect is calculated based on the formula (4) below.

$$\begin{matrix}[ Numeral 4 ] & \\ fd = \frac{fup - fdn}{2} & ( 4 )\end{matrix}$$

A relative velocity V of the target is calculated based on the formula (5) below, by use of the frequency fd.

$$\begin{matrix}[ Numeral 5 ] & \\ V = \frac{c}{2 \times fo} & ( 5 )\end{matrix}$$

In the explanation above, a longitudinal distance and a relative velocity of an ideal target are calculated. In reality, the radar apparatus 1 receives plural reflection waves RW concurrently from a plurality of targets. Thus, the frequency spectrum into which the Fourier transformer 62 has transformed the beat signal obtained from the reception signals includes information corresponding to the plurality of targets.

The next explanation is about the processing for peak extraction, azimuth calculation, and pairing in a target information acquisition processing.

<3-1. Peak Extraction>

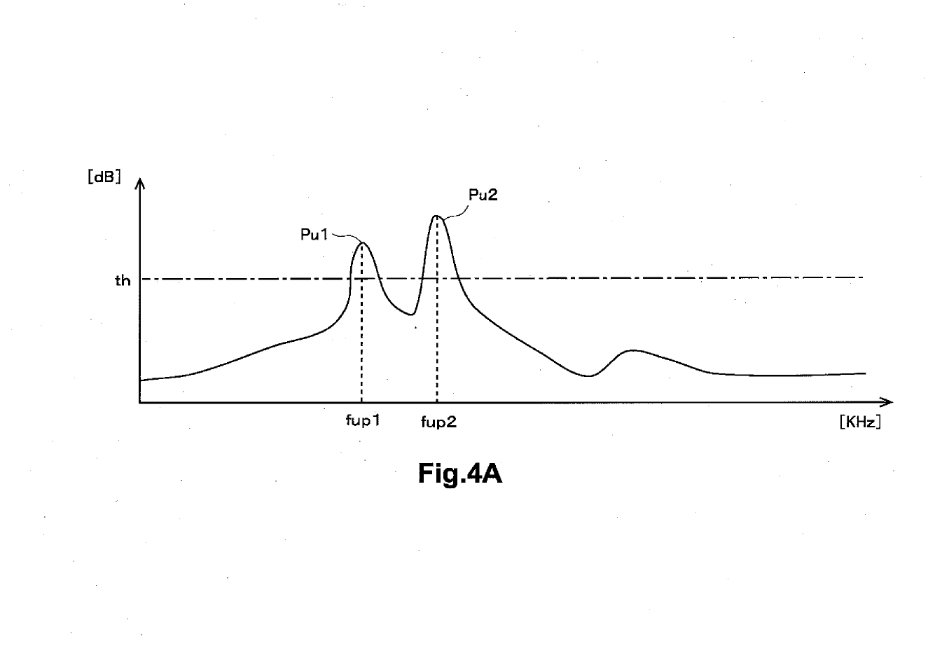

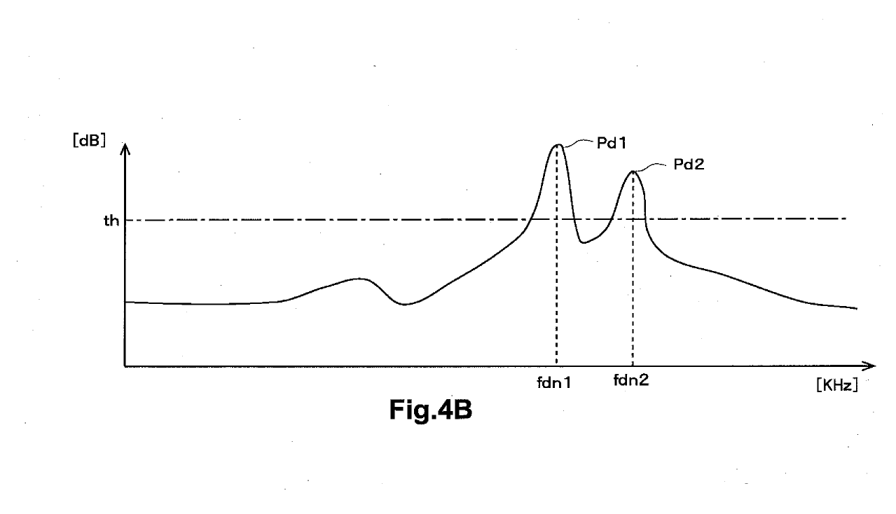

FIG. 4A shows a frequency spectrum in the up section, while FIG. 4B shows a frequency spectrum in the down section. In the both figures, each of the horizontal axes represents frequency [kHz], while each of the vertical axes represents power of a signal [dB].

A peak extraction part 71 extracts a frequency at which a peak higher than a prescribed threshold th appears. In the frequency spectrum of the up section shown in FIG. 4A, the peak extraction part 71 extracts a frequency fup1 of a peak Pu1 and a frequency fup2 of a peak Pu2. In the frequency spectrum of the down section shown in FIG. 4B, the peak extraction part 71 extracts a frequency fdn1 of a peak Pd1 and a frequency fdn2 of a peak Pd2. Hereinafter, the peak of the extracted frequency is referred to as “frequency peak.”

<3-2. Azimuth Calculation>

The frequency spectrums of both of the up section and the down section as shown in FIG. 4A and FIG. 4B are obtained based on the reception signal received by each of the reception antennas 51. Thus, the Fourier transformer 62 derives the two frequency spectrums of the up section and the down section based on each of the reception signals received by the four reception antennas 51.

Since each of the four reception antennas 51 receives the reflection wave RW reflected by the same target, the frequencies of the frequency peaks of the reflection wave reflected by one target are the same at the four reception antennas 51. However, the phase information of the frequency peaks differs from each other at the four reception antennas 51. This is because the four reception antennas 51 are located at different positions, and thereby the reflection signals at the four reception antennas 51 vary in phase.

An azimuth estimation part 72 performs an azimuth calculation processing by use of ESPRIT (Estimation of Signal Parameters via Rotational Invariance Techniques) or another method. The azimuth estimation part 72 estimates the angles of respective targets based on a plurality of angle peaks derived from one frequency peak. The angle peak is a peak exceeding a prescribed threshold in the angle spectrum.

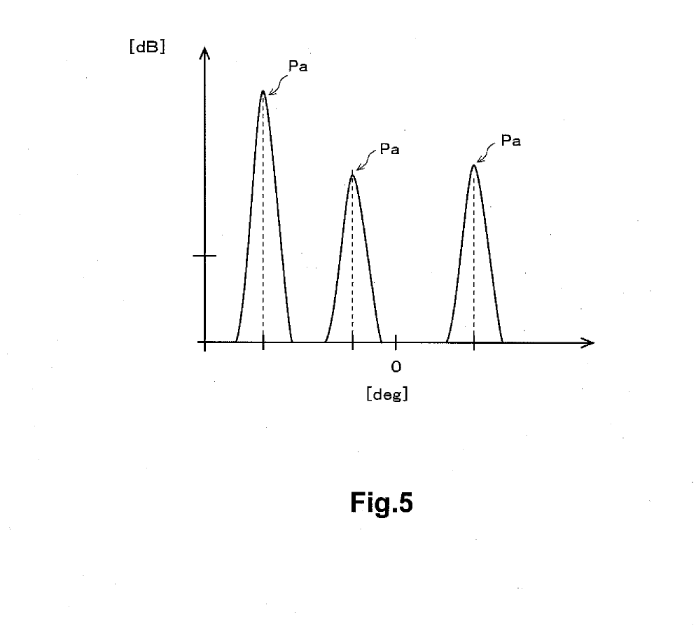

FIG. 5 shows one example of the angle spectrum. FIG. 5 conceptually shows the angles estimated through the azimuth calculation processing by the azimuth estimation part 72, as the angle spectrum. In FIG. 5, the horizontal axis represents angle [deg], while the vertical axis represents power [dB] of a signal. Each of peaks Pa in the angle spectrum shows an angle estimated through the azimuth calculation processing. The plurality of angle peaks derived from one frequency peak as above show respective angles and angle powers of a plurality of targets whose beat frequencies are the same.

A derivation possible number of the angle peaks of the same frequency is, for example, three in ESPRIT. That is, the azimuth estimation part 72 derives three angle peaks at most from one frequency peak. The azimuth estimation part 72 derives the angle peaks in terms of every frequency peak both in the up section and the down section. For ease of explanation, hereafter it is assumed that one angle peak is obtained from one frequency peak in the following explanation. Thus, the frequency peaks Pu1, Pu2, Pd1 and Pd2 may correspond respectively to the angle peaks Pu1, Pu2, Pd1 and Pd2 in the following explanation.

<3-3. Pairing>

As above, the peak extraction part 71 derives a frequency peak, and the azimuth estimation part 72 derives an angle peak from the frequency peak to estimate the angle of a target. The angle peak in each of the up section and the down section has the parameters of “frequency,” “angle” and “angle power.”

A derivation part 73 derives pair data by pairing an angle peak in the up section and an angle peak in the down section in a pairing processing. The derivation part 73 calculates a Mahalanobis distance serving as an index of reliability of a pair, based on the formula (6) below by use of the parameters (angle and angle power) of the angle peak in the up section and the parameters (angle and angle power) of the angle peak in the down section.

The derivation part 73 calculates a Mahalanobis distance MD based on the formula (6) below specifically in the following manner: obtaining a value by squaring an angle difference θd between the angle peak of the up section and the angle peak of the down section to be multiplied by a prescribed coefficient a; obtaining another value by squaring an angle power difference θp between the angle peak of the up section and the angle peak of the down section to be multiplied by a prescribed coefficient b; and summing the two values above.

[Numeral 6]

MD=a×(θd)²+b×(θp)² (6)

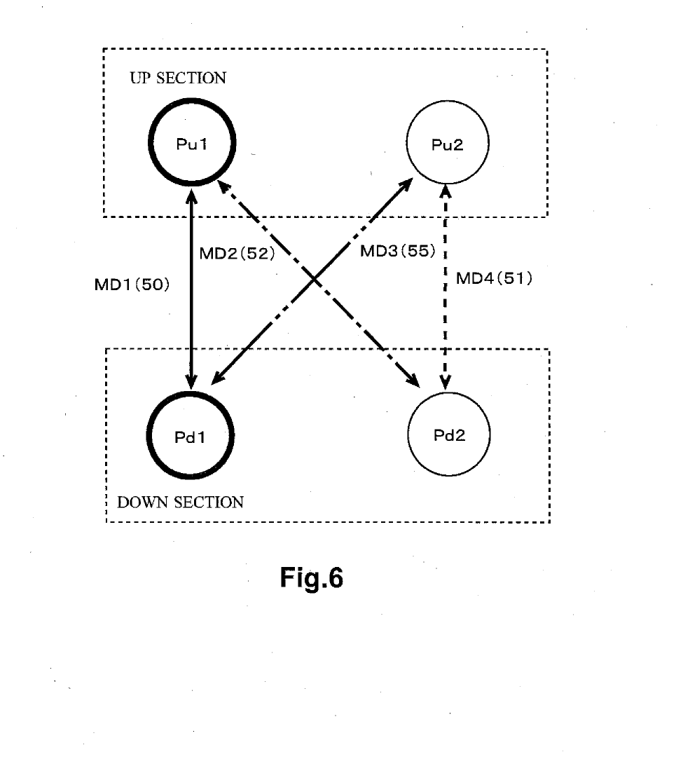

Then, the derivation part 73 performs the pairing processing based on the calculated Mahalanobis distance MD. FIG. 6 shows an example of the pairing processing based on the Mahalanobis distance. The derivation part 73 calculates a Mahalanobis distance MD for each of possible pairs, including one of the angle peaks of the up section and one of the angle peaks of the down section. That is, the derivation part 73 calculates a Mahalanobis distance MD for each of four pairs: the pair of the angle peaks Pu1 and Pd1; the pair of the angle peaks Pu1 and Pd2; the pair of the angle peaks Pu2 and Pd1; and the pair of the angle peaks Pu2 and Pd2.

Specifically, the derivation part 73 calculates a Mahalanobis distance MD1 (distance: 50) for the pair of the angle peaks Pu1 and Pd1, indicated by a solid line, and a Mahalanobis distance MD2 (distance: 52) for the pair of the angle peaks Pu1 and Pd2, indicated by a dot chain line. The derivation part 73 also calculates a Mahalanobis distance MD3 (distance: 55) for the pair of the angle peaks Pu2 and Pd1, indicated by a two-dot chain line, and a Mahalanobis distance MD4 (distance: 51) for the pair of the angle peaks Pu2 and Pd2, indicated by a broken line.

After calculating the Mahalanobis distances MD for all of the pairs, the derivation part 73 extracts the optimum pair that has the minimum Mahalanobis distance MD to determine pair data. After determining one pair data, the derivation part 73 determines another pair data of the pair having the minimum Mahalanobis distance MD among the angle peaks excluding the angle peaks of the determined pair data.

In FIG. 6, the pair having the minimum Mahalanobis distance MD (hereinafter, also referred to as “first Mahalanobis distance”) is of the angle peaks Pu1 and Pd1. However, these angle peaks may be paired by mistake. That is, even in the case where the angle peak Pu1 of the up section and the angle peak Pd1 of the down section are respectively related to different reflection points, they may be determined as pair data as long as these angle peaks have approximate angles and angle powers.

Therefore, the derivation part 73 derives a pair having the second minimum Mahalanobis distance MD (hereinafter, also referred to as “second Mahalanobis distance”) and stores the Mahalanobis distance MD of the derived pair in a memory 63. Specifically, the derivation part 73 picks up either one of the angle peaks of the up section and the angle peak of the down section, which make the pair having the first Mahalanobis distance, to use as one of the angle peaks making the pair having the second Mahalanobis distance. Then, the derivation part 73 picks up one of the angle peaks excluding the ones making the pair having the first Mahalanobis distance, to use as the other angle peak making the pair having the second Mahalanobis distance. Thereby, the derivation part 73 can derive the pair having the second Mahalanobis distance. Then, the derivation part 73 determines the validity of the pair for the pair data by use of the first Mahalanobis distance and the second Mahalanobis distance. The processing for determining the validity of the pair is detailed later. The memory 63 is, for example, an erasable programmable read only memory (EPROM) or a flash memory.

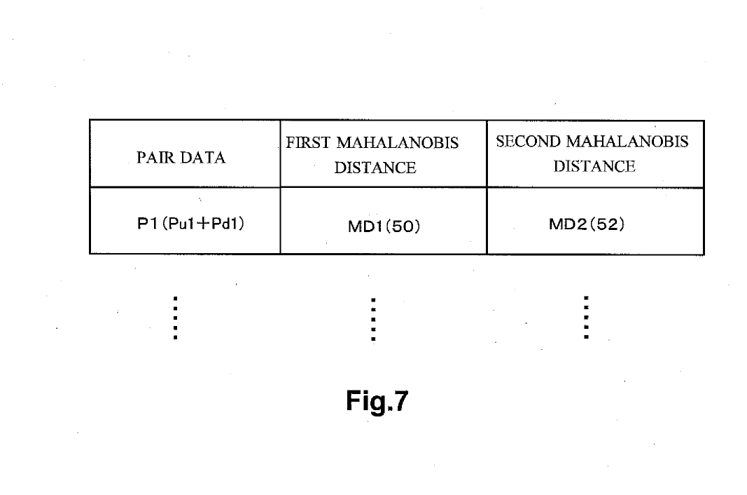

FIG. 7 shows one example of the information on the pair data stored in the memory 63. As shown in FIG. 6, the memory 63 stores the first Mahalanobis distance MD1 (distance: 50) and the second Mahalanobis distance MD2 (distance: 52), of a pair data P1 of the pair of the angle peaks Pu1 and Pd1.

Among the pairs including the angle peak Pu1 of the up section, the Mahalanobis distance MD2 (distance: 52) of the pair with the angle peak Pd2 of the down section corresponds to a second minimum Mahalanobis distance. Among the pairs including the angle peak Pd1 of the down section, the Mahalanobis distance MD3 (distance: 55) of the pair with the angle peak Put of the up section corresponds to another second minimum Mahalanobis distance. Here, the Mahalanobis distance MD2 that is smaller than the Mahalanobis distance MD3 becomes the second Mahalanobis distance. That is, the Mahalanobis distance MD2 of the pair of the angle peak Put of the up section and the angle peak Pd2 of the down section is deemed as the second Mahalanobis distance.

The memory 63 stores the first Mahalanobis distance and the second Mahalanobis distance of the pair data P1, and also the first Mahalanobis distance and the second Mahalanobis distance for each of the pair data other than the pair data P1.

The derivation part 73 derives a longitudinal distance R of the target by use of the formulas (2) and (3) above, and also derives a relative velocity V of the target by use of the formulas (4) and (5) above.

The derivation part 73 derives an angle θ of the target based on the formula (7) below, where an angle of the up section is represented by θup, and an angle of the down section is represented by θdn. The derivation part 73 calculates a lateral distance of the target by use of trigonometric functions based on the derived angle θ and the derived longitudinal distance R of the target.

$$\begin{matrix}[ Numeral 7 ] & \\ θ = \frac{θ up + θ dn}{2} & ( 7 )\end{matrix}$$

### 4. Flowchart of Processing

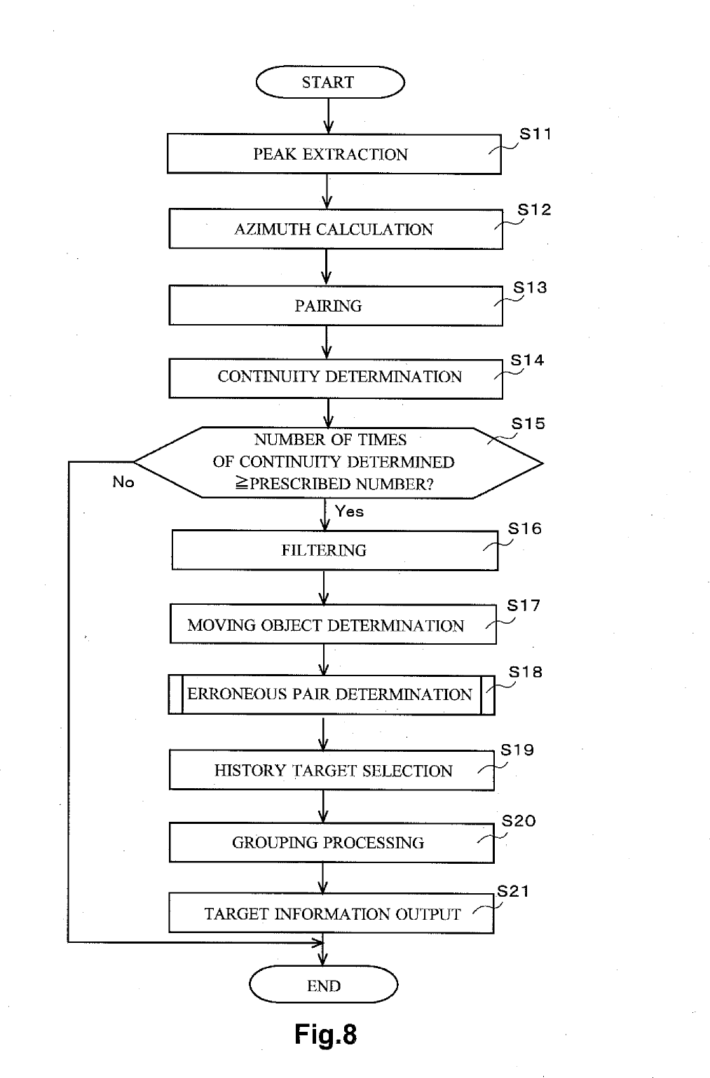

The next explanation is about the overall flow of the target information acquisition processing performed by the data processor 7. FIG. 8 shows the flowchart of the target information acquisition processing. The target information acquisition processing shown in FIG. 8 including the above-described peak extraction, azimuth calculation and pairing is performed by the data processor 7 to obtain the target information of a target and output the obtained target information to the vehicle controller 2. The data processor 7 repeats the target information acquisition processing in a prescribed cycle (for example, 1/20 second cycle). Before the start of the target information acquisition processing, the frequency spectrums of both of the up section and the down section are transmitted from the Fourier transformer 62 to the data processor 7.

First, the peak extraction part 71 of the data processor 7 extracts a frequency peak in each of the frequency spectrums (step S11). The peak extraction part 71 extracts a frequency forming a peak having a signal level exceeding a prescribed threshold th in each of the frequency spectrums of each of the up section and the down section. In the examples shown in FIG. 4A and FIG. 4B, the peak extraction part 71 extracts the frequencies fup1, fup2, fdn1 and fdn2 respectively corresponding to the frequency peak signals Pu1, Pu2, Pd1 and Pd2.

Next, the azimuth estimation part 72 of the data processor 7 estimates an angle of the target by deriving an angle peak through an azimuth calculation processing based on the frequency peak by use of ESPRIT (step S12).

Next, the derivation part 73 of the data processor 7 pairs an angle peak of the up section and an angle peak of the down section based on the reliability of the pair (step S13). Specifically, the derivation part 73 calculates the Mahalanobis distances MD for all of the pairs each of which includes an angle peak of the up section and an angle peak of the down section, and determines as the pair data P1 one pair having the minimum Mahalanobis distance MD. The derivation part 73 derives another pair having the second Mahalanobis distance, and stores the first Mahalanobis distance and the second Mahalanobis distance relevant to the pair data P1 in the memory 63.

The derivation part 73 derives the target information including a longitudinal distance, a relative velocity and a lateral distance of the pair data. The derivation part 73 determines temporal continuity between the pair data derived in the present target information acquisition processing (hereinafter, referred to as “present processing”) and the pair data derived in the target information acquisition processing in the past (hereinafter, referred to as “past processing”) (step S14).

The derivation part 73 estimates the target information on the pair data to be obtained in the present processing, having temporal continuity with the pair data obtained in the past processing. In an example, the derivation part 73 estimates the position or other information of the preceding vehicle to be obtained in the present processing, the preceding vehicle having been derived in the past processing. Thereby, the derivation part 73 derives the pair data including the estimated target information (hereinafter, referred to as “estimation pair data”).

Then, the derivation part 73 selects one pair data having the target information approximated to that of the estimation pair data among a plurality of pair data derived in the present processing. Then, the derivation part 73 determines that the selected pair data has continuity with the pair data derived in the past processing.

The derivation part 73 determines the continuity in terms of every pair data derived in the past processing and stored in the memory 63. When deriving no pair data having approximate parameters to the estimation pair data in the present processing, the derivation part 73 adopts the estimation pair data having continuity with the pair data derived in the past processing as the pair data derived in the present processing. The processing for assuming that target information is obtained in spite of none of the target information obtained in the present processing is called “extrapolation processing.”

The derivation part 73 determines that the pair data derived in the present processing in which the continuity with the pair data derived in the past processing is not found is the new pair data derived for the first time in the present processing.

The derivation part 73 determines whether or not the continuous number of times of the determination on the temporal continuity existing between the pair data derived in the present processing and the pair data derived in the past processing is equal to or above a prescribed number (step S15). In the case where the continuous number of times relevant to the continuity is three or above (Yes at the step S15), the derivation part 73 performs a filtering processing (step S16) indispensable to the output of the target information to the vehicle controller 2.

The case where the continuous number of times relevant to the continuity is three is the case when the derivation part 73 derived the pair data P1 for the first time in the processing 2-times before, further derived the pair data having the temporal continuity with the pair data P1 in the last processing, and derives the pair data having the temporal continuity with the pair data P1 in the present processing. In the case where the continuous number of times relevant to the continuity is less than three (No at the step S15), the continuous number of times relevant to the continuity is determined in or after the next target information acquisition processing (hereinafter, referred to as “in or after the next processing”).

As above, the data processor 7 determines whether the pair data of the same target has been derived continuously plural times in the target information acquisition processing, thereby preventing the erroneous pair data from being output to the vehicle controller 2. In the case where the pair data derived in the past processing is erroneous pair data, the pair data having the target information approximated to that of the estimation pair data estimated from the erroneous pair data is not to be derived in the present processing. As a result, the extrapolation processing is performed in the present processing, and further performed in or after the next processing. In the case where a prescribed number of times or more the extrapolation processing is repeated successively, the target information of the pair data stored in the memory 63 is to be deleted from the memory 63. That is, the target information of the erroneous pair data is deleted from the memory 63, thereby preventing the target information of the erroneous pair data from being output to the vehicle controller 2.

Next, the derivation part 73 levels the target information of the pair data in a time axis direction by performing the filtering processing to the pair data in which the continuous number of times relevant to the continuity is equal to or above a prescribed number (step S16). Specifically, the derivation part 73 derives weighted-averaged data (hereinafter, referred to as “filter data”) from the target information of the pair data derived in the present processing as an instantaneous value and the target information of the estimation pair data used in the continuity determination processing.

In an example, the derivation part 73 multiplies “0.25” to the value of the target information of the pair data derived in the present processing, and “0.75” to the value of the target information of the estimation pair data, and then sums the two calculated values to derive the value of the target information of the filter data. The value of the target information of the pair data derived as an instantaneous value may be abnormal in some case due to the influence of noise or another factor. However, the filtering processing can prevent the values of the target information from becoming abnormal.

Next, the derivation part 73 performs a moving object determination processing to set a moving object flag and a preceding vehicle flag for the filter data (step S17). The derivation part 73 derives, first, an absolute velocity and a traveling direction of the target shown by the filter data, based on the relative velocity of the filter data and the velocity of the own vehicle obtained from the vehicle velocity sensor 81.

When the absolute velocity of the filter data is equal to or above a prescribed velocity (for example, 1 km/h), the derivation part 73 determines that the filter data corresponds to the data of a moving object, and sets the moving object flag “on.” When the absolute velocity of the filter data is less than a prescribed velocity (for example, 1 km/h), the derivation part 73 determines that the filter data corresponds to the data of a static object, and sets the moving object flag “off.”

When the traveling direction of the target shown by the filter data is the same as the one of the own vehicle, and further the absolute velocity thereof is equal to or above a prescribed velocity (for example, 18 km/h), the derivation part 73 sets the preceding vehicle flag “on.” When the filter data does not satisfy these conditions, the derivation part 73 sets the preceding vehicle flag “off.”

Next, a determination part 74 of the data processor 7 performs an erroneous pair determination processing to determine the validity of the pair of the pair data corresponding to the filter data (step S18). Hereafter, the erroneous pair determination processing is detailed.

### 5. Erroneous Pair Determination Processing

The first explanation here is about the processing to be performed in the case where the pair data corresponds to erroneous pair data. In the case where the pair data corresponds to erroneous pair data, an output part 75 of the data processor 7 does not output the target information of the pair data to the vehicle controller 2. That is, in the case where the continuous number of times relevant to the continuity of the pair data is less than a prescribed number (No at the step S15), the output part. 75 does not output the target information of the pair data to the vehicle controller 2. In the case where the parameters of the angle peaks of the up section and the down section are approximated respectively, it is possible to generate erroneous pair data with erroneous pair since the pair data is determined based on the parameters of the angle peaks.

If the erroneous pair data derived in the present processing is included in the estimation range of the estimation pair data, the continuous number of times relevant to the continuity of the erroneous pair data may become equal to or above a prescribed number, and the output part 75 may output the target information of the erroneous pair data to the vehicle controller 2. When the estimation pair data is the pair data estimated from the pair data rightly combined in a past processing, there cannot be temporal continuity between the estimation pair data and the erroneous pair data derived in the present processing. However, since the estimation pair data have a prescribed estimation range (longitudinal distance range, lateral distance range, relative velocity range, etc.) based on the target information, it may be determined that there is temporal continuity with the erroneous pair data whose target information is included in the estimation range.

A possible simple method of accurately determining whether or not pair data is erroneous pair data requires the increase of the number of times of determination of continuity to all of the pair data. However, the increase of the number of times of determination increases the load in processing on the radar apparatus 1. As a result, there is a possibility that the output part 75 may not early output the target information to the vehicle controller 2, and thereby the vehicle controller 2 may perform vehicle control late.

Here, the determination part 74 performs the following erroneous pair determination processing to determine validity of pairs based on the parameters of angle peaks. Then, the determination part 74 increases the number of times of the continuity determination processing only to the pair data having a large possibility of being erroneous pair data (low validity of being right pair). The output part 75 early outputs to the vehicle controller 2 the target information of the pair data having a low possibility of being erroneous pair data (high validity of being right pair).

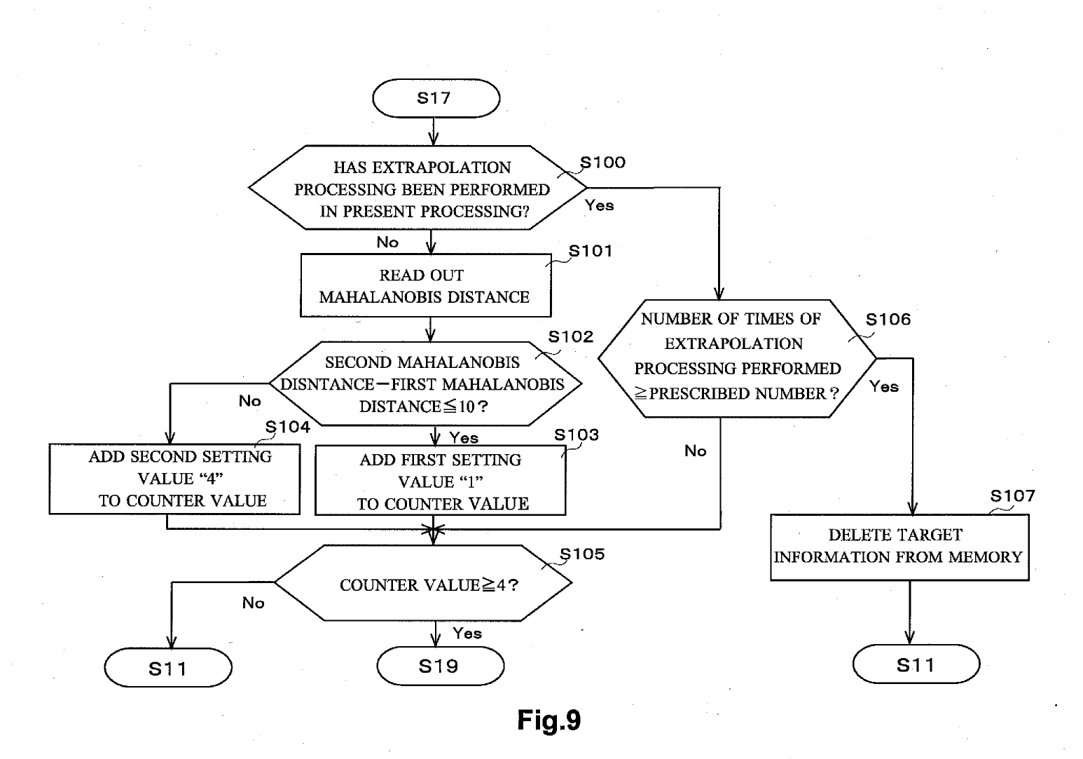

FIG. 9 shows the flowchart of the erroneous pair determination processing. The determination part 74 determines whether the extrapolation processing has been performed this time in the continuity determination processing of the step S14 (step S100). When the extrapolation processing has not been performed (No at the step S100), the determination part 74 reads out from the memory 63 the first Mahalanobis distance and the second Mahalanobis distance of the pair data of the present processing (step S101). The case where the extrapolation processing has not been performed is the case where the pair data having temporal continuity with the estimation pair data exists in the present processing. The determination part 74 reads out from the memory 63, for example, the Mahalanobis distance MD1 (distance: 50) that is the first Mahalanobis distance of the pair data P1 and the Mahalanobis distance MD2 (distance: 52) that is the second Mahalanobis distance thereof.

Next, the determination part 74 calculates the difference between the first Mahalanobis distance and the second Mahalanobis distance relevant to the pair data of the present processing, and determines whether or not the difference is equal to or below a prescribed value (for example, distance: 10) representing the reliability of pairing (step S102). In an example, the determination part 74 determines whether or not the value obtained by subtracting the first Mahalanobis distance from the second Mahalanobis distance is equal to or below 10.

In the case where the difference value is equal to or below the prescribed value (Yes at the step S102), the determination part 74 adds a first setting value (for example, 1) to the value of an output counter of the filter data corresponding to the pair data (step S103). In the case where the difference value is equal to or below the prescribed value, the reliability of the pair of the determined pair data is low, and thus it is possible that the pair data may be erroneous pair data. In this case, a relatively small value shall be set as the first setting value so as to represent that the reliability thereof is low.

In the case where the difference value is above the prescribed value (No at the step S102), the determination part 74 adds a second setting value (for example, 4) to the value of the output counter of the filter data corresponding to the pair data (step S104). In the case where the difference value is above the prescribed value, the reliability of the pair of the determined pair data is high, and thus the possibility of being erroneous pair data is low. In this case, a relatively large value shall be set as the second setting value so as to represent that the reliability thereof is high.

As above, in the case where the difference between the first Mahalanobis distance and the second Mahalanobis distance is relatively small, it is highly possible that the pair data has been made by an erroneous pair. That is, since it is deemed that the validity of the pair of the pair data is low, the determination part 74 sets a relatively small value as the value to be added to the output counter.

In the case where the difference between the first Mahalanobis distance and the second Mahalanobis distance is relatively large, it is highly possible that the pair data has been made by a right pair. That is, since it is deemed that the validity of the pair of the pair data is high, the determination part 74 sets a relatively large value as the value to be added to the output counter.

In the case where the value of the output counter of the filter data is equal to or above a prescribed value (for example, 4) (Yes at the step S105), the derivation part 73 performs a history target selection processing (step S19) that is explained later. Then, the output part 75 outputs to the vehicle controller 2 the target information after the history target selection processing and another processing.

In the case where the value of the output counter of the filter data is below the prescribed value (No at the step S105), the erroneous pair determination processing is ended. Then, the value of the output counter is set in or after the next erroneous pair determination processing. As above, in the case where the value of the output counter is below the prescribed value, the output part 75 delays the timing for outputting the target information of the filter data compared to standard output timing. The radar apparatus 1 thereby can determine the validity of the pair in accordance with the comparison result of reliability of plural pairs, and obtain the target information of the pair data of the right pair. The standard output timing is when in the case where the erroneous pair determination of the step S18 included in the target information acquisition processing is performed to the filter data for the first time, the target information of the filter data is output to the vehicle controller 2 within the same target information acquisition processing. That is, the timing is when the value of the output counter of the filter data is equal to or above the prescribed value in a single target information acquisition processing, and then the target information of the filter data is output to the vehicle controller 2 within the same target information acquisition processing.

Here, the initial value of the output counter is “0.” That is, in the case of the first filtering processing by the derivation part 73, the value of the output counter of the pair data is “0.” The difference value obtained by subtracting the first Mahalanobis distance MD1 from the second Mahalanobis distance MD2 of the pair data P1 (distance: 52−distance: 50=distance: 2) is less than distance: 10 (Yes at the step S102). Thereby, the determination part 74 adds “1” to the value of the counter of the filter data (step S103). Since the value of the output counter after the addition is less than “4” (No at the step S105), the output part 75 does not output the target information to the vehicle controller 2.

In the case where the value of the output counter of the filter data obtained in the present processing is “1,” the output part 75 can output the target information of the filter data to the vehicle controller 2 only after the target information acquisition processing is performed at least three times more. The counter value increases one by one, in the case where the difference between the first Mahalanobis distance and the second Mahalanobis distance of the pair data obtained in or after the next processing is equal to or below the prescribed value even if the pair data having temporal continuity with the filter data obtained in the present processing is obtained in or after the next processing.

Therefore, at least three times of the target information acquisition processing is required so that the target information of the filter data is output to the vehicle controller 2. As above, the timing of outputting the pair data having low reliability to the vehicle controller 2 is delayed, and thereby the radar apparatus 1 can determine the validity of the pair in accordance with the difference of Mahalanobis distances MD of plural pairs, and can determine the pair data of a right pair.

In the case where the difference between the first Mahalanobis distance and the second Mahalanobis distance becomes above the prescribed value (No at the step S102) in or after the next processing, that is, during the period where the timing of outputting the target information is delayed, the determination part 74 adds the second setting value “4” to the value of the output counter (step S104). As a result, the value of the output counter becomes equal to or above “4” (Yes at the step S105). The output part 75 outputs the target information of which the output is delayed, immediately after the history target selection processing and another processing are performed. The radar apparatus 1 thereby can output to the vehicle controller 2 the target information immediately after it is determined that the validity of the pair is high even if the output thereof is delayed.

As for the pair data of which the continuous number of times relevant to the continuity is determined as being equal to or above the prescribed number for the first time at the step S15 in the present processing, the determination part 74 adds the second setting value “4” to the value of the output counter in the case where the difference between the first Mahalanobis distance and the second Mahalanobis distance is above the prescribed value, that is, in the case where the reliability of the pairing is high (step S104). Thereby, the output part 75 can early output to the vehicle controller 2 the target information of the filter data of which the continuous number of times relevant to the continuity is determined as being equal to or above the prescribed number for the first time in the present processing.

At the step S100 again, in the case where the extrapolation processing is performed (Yes at the step S100), the determination part 74 determines whether or not with this extrapolation processing of the filter data in the present processing the number of times of the extrapolation processing performed becomes equal to or above the prescribed number (for example, 3) (step S106). The case of the extrapolation processing performed is the case where there is no pair data having temporal continuity with the estimation pair data in the present processing.

In the case where the number of times of the extrapolation processing performed is equal to or above the prescribed number (Yes at the step S106), the determination part 74 deletes from the memory 63 the target information of the filter data in the present processing, and the target information of the filter data in the past processing having the temporal continuity with the filter data in the present processing (step S107), and then performs the next target information acquisition processing from the first step. Thereby, since the radar apparatus 1 does not output the erroneous pair data to the vehicle controller 2, the vehicle controller 2 can perform appropriate vehicle control.

In the case where the number of times of the extrapolation processing performed is less than the prescribed number (No at the step S106), the determination part 74 determines whether or not the value of the output counter is four or above (step S105) without adding any value to the value of the output counter.

In FIG. 8 again, the derivation part 73 selects from all of the pair data a prescribed number (for example, 20) of filter data to be treated as history targets in or after the next processing (step S19). The history target processing is to select the filter data traveling in the same traveling lane with that of the own vehicle and existing at the position relatively close to the own vehicle. In other words, the processing is to select the filter data in which the moving object flag is “on,” and further the preceding vehicle flag is “on.” The derivation part 73 determines whether a target is traveling in the same traveling lane as that of the own vehicle, by grasping the shape of the traveling lane based on the steering angle of the own vehicle obtained from the steering sensor 82. The peak extraction processing or the like to derive the pair data having temporal continuity in or after the next processing is preferentially performed to the filter data selected as the history targets compared to other filter data.

Next, the derivation part 73 performs a grouping processing to make a group with all of the filter data relevant to the same target among all of the filter data (step S20). The reflection waves are the waves reflected respectively by a plurality of reflection points of the preceding vehicle. Since a plurality of reflection waves RW respectively reflected by the plurality of reflection points reach the reception antennas 51 of the radar apparatus 1, a plurality of filter data relevant to the plurality of reflection points are derived. The plurality of filter data correspond to the data of the same target. Thus, the derivation part 73 makes a group with such plurality of filter data. In an example, the derivation part 73 makes a group with the plurality of filter data having approximate target information. As for the target information of the grouped filter data, for example, the average value of the target information of the plurality of grouped filter data is used.

Next, the output part 75 outputs the target information of the filter data to the vehicle controller 2 (step S21). The output part 75 selects a prescribed number (for example, 8) of the filter data in the case where there are a lot of filter data, to output to the vehicle controller 2.

### CONCLUSION

As explained so far, in the case where the continuity of the pair data is ensured a prescribed number of times as explained in the part of the step S15 in FIG. 8, and further where the reliability of the pairing of the pair data is high, the radar apparatus 1 of the embodiment immediately outputs the target information to the vehicle controller 2.

While in the case where the reliability of the pairing of the pair data is low, the radar apparatus 1 delays the output of the pair data to the vehicle controller 2 by the period required for performing the target information acquisition processing four times at maximum after the continuity of the pair data is ensured a prescribed number of times as explained in the part of the step S15. In the case where the reliability of the pairing of the pair data changes from a low state (the value of the output counter is less than 3) to a high state (the value of the output counter is four or above) during the output being delayed, the radar apparatus 1 immediately outputs the target information to the vehicle controller 2.

The radar apparatus 1 also outputs the pair data to the vehicle controller 2 in the case where: as for the pair data of which the reliability of the pairing is low, the continuity of the pair data is ensured a prescribed number of times as explained in the part of the step S15 without the extrapolation processing being performed to the pair data; and further the continuity thereof is ensured four successive times.

In the case where the pair data corresponds to erroneous pair data, the possibility that seven times in total the continuity is ensured is relatively low. In this case, the radar apparatus 1 performs the extrapolation processing before the value of the output counter reaches “4.” As a result, since any value is not added to the value of the output counter of the filter data and the extrapolation processing is performed a prescribed number of times or more, the target information of the filter data is deleted from the memory 63.

As above, the radar apparatus 1 immediately outputs the target information to the vehicle controller 2 in the case where the reliability of the pairing of pair data is high; and delays the output of the target information to the vehicle controller 2 in the case where the reliability of the pairing is low. Thereby, the radar apparatus 1 can output right target information to the vehicle controller 2 early, and can suppress the output of erroneous target information to the vehicle controller 2.

### MODIFICATION

The embodiment of the invention has been described so far. However, the invention is not limited to the embodiment described above, and may provide various modifications. Hereafter, these modifications are described. All of the embodiments including the embodiment described above and the embodiments to be described below can be arbitrarily combined with others.

The embodiment described above adopts “Mahalanobis distance” serving as an index of the reliability of the pair of angle peaks. However, another method is available as long as the method can calculate the reliability of the pair based on the parameters of angle peaks. “Linear discriminant point (discriminant function)” may be adopted for calculation of the reliability. The method by use of the linear discriminant point is to calculate a discriminant point based on a plurality of parameters of the pair data, thereby determining the pair data having the highest point of the discriminant point as a right pair. In this method, the radar apparatus 1 may determine whether to output the target information of the filter data to the vehicle controller 2 by calculating the reliability in accordance with the point difference between the pair data having the highest discriminant point and the pair data having the second-highest discriminant point.

In the embodiment described above, the erroneous pair determination processing shown in the part of the step S18 of FIG. 8 may be performed in an order different from the one described in the embodiment above. In an example, the radar apparatus 1 may perform the erroneous pair determination processing after the processing for determining the number of times of continuity (step S15) and before the filtering processing (step S16). This order is to perform the erroneous pair determination to the pair data before the filtering processing, thereby reducing the load of the processing on the data processor 7.

In the embodiment described above, in the case where the value of the output counter of the filter data in the erroneous pair determination processing of FIG. 9 becomes four or above, the output part 75 outputs the target information to the vehicle controller 2. However, in the case where the distance between the first Mahalanobis distance and the second Mahalanobis distance is 10 or less even when the value of the output counter of the filter data becomes four or above, the radar apparatus 1 may not output the target information. That is, the radar apparatus 1 may output the target information to the vehicle controller 2 only in the case where the value of the output counter is four or above and further the difference between the two is above 10. In this method, the radar apparatus 1 can delay the output of the filter data to the vehicle controller 2 in the case where the difference between the first Mahalanobis distance and the second Mahalanobis distance is relatively small even when a prescribed condition in terms of the value of the output counter is satisfied. Here, the value of the difference between the first Mahalanobis distance and the second Mahalanobis distance is just one example, and another value may be used.

In the embodiment described above, the number of the transmission antenna 40 of the radar apparatus 1 is one; while the number of the reception antennas 51 thereof is four. This is just an example of the numbers of antennas for the transmission antenna 40 and the reception antenna 51. Other numbers of antennas are available as long as a radar apparatus 1 can obtain a plurality of target information.

In the embodiment described above, ESPRIT is used as an azimuth estimation method on the radar apparatus 1. However, DBF (Digital Beam Forming), PRISM (Propagator method based on Improved Spatial-smoothing Matrix), MUSIC (Multiple Signal Classification), or another method may also be available as the azimuth estimation method, other than ESPRIT.

In the embodiment described above, the radar apparatus 1 is installed in the front part of the vehicle (for example, in the front bumper). However, a radar apparatus 1 may be installed in either one of the rear part of the vehicle (for example, a rear bumper), the left side thereof (for example, a left door mirror) and the right side thereof (for example, a right door mirror), as long as the position of the radar apparatus 1 enables the output of transmission waves outside the vehicle.

In the embodiment described above, the transmission antenna may output either one of electric waves, ultrasonic waves, light, laser and others, as long as the method enables the acquisition of the target information thereof.

In the embodiment described above, the radar apparatus 1 may be used in a place other than in a vehicle. The radar apparatus 1 may be used, for example, in an airplane or a ship.

In the embodiment described above, various functions are implemented by software, specifically by the CPU calculation processing based on programs. However, some of these functions may be implemented by electrical hardware circuits. Contrarily, some of the functions implemented by a hardware circuit may be implemented by software.

While the invention has been shown and described in detail, the foregoing description is in all aspects illustrative and not restrictive. It is therefore understood that numerous other modifications and variations can be devised without departing from the scope of the invention.

What is claimed is:

1. A radar apparatus that pairs an angle peak of an up section in which a frequency of a transmission signal increases and an angle peak of a down section in which the frequency of the transmission signal decreases based on a reliability of a pair, the radar apparatus comprising a signal processor configured to:
derive a first index that shows a highest level of the reliability of a pair in a plurality of pairs of the angle peaks and a second index that shows another level of the reliability of another pair of the angle peaks, the second index being lower than the first index in the reliability but being higher than other indexes excluding the first index; and
determine a validity of the pair having the highest level of the reliability based on a comparison result between the first index and the second index.

2. The radar apparatus of claim 1, wherein
the first index corresponds to a shortest Mahalanobis distance and the second index corresponds to a second-shortest Mahalanobis distance, and
the signal processor determines that the validity is low in a case where a difference between the shortest Mahalanobis distance and the second-shortest Mahalanobis distance is equal to or below a prescribed value.

3. The radar apparatus of claim 2, wherein the signal processor is further configured to:
output target information to a vehicle controller that controls a behavior of a vehicle, wherein
the signal processor delays an output timing of the target information to the vehicle controller compared to a standard output timing in a case where the validity is low.

4. The radar apparatus of claim 3, wherein
in another case where the difference between the shortest Mahalanobis distance and the second-shortest Mahalanobis distance is above the prescribed value as for the target information of which the output timing is delayed, the signal processor outputs the target information to the vehicle controller.

5. A vehicle control system that controls a behavior of a vehicle, the vehicle control system comprising:
the radar apparatus of claim 1; and
a vehicle controller that controls the behavior of the vehicle based on target information output by the radar apparatus.

6. A signal processing method performed by a signal processor of a radar apparatus that pairs an angle peak of an up section in which a frequency of a transmission signal increases and an angle peak of a down section in which the frequency of the transmission signal decreases based on a reliability of a pair, the signal processing method comprising the steps of:
(a) deriving a first index that shows a highest level of the reliability of a pair in a plurality of pairs of the angle peaks and a second index that shows another level of the reliability of another pair of the angle peaks, the second index being lower than the first index in the reliability but being higher than other indexes excluding the first index; and
(b) determining a validity of the pair having the highest level of the reliability based on a comparison result between the first index and the second index.

7. The signal processing method of claim 6, wherein
the first index corresponds to a shortest Mahalanobis distance and the second index corresponds to a second-shortest Mahalanobis distance, and
the step (b) determines that the validity is low in a case where a difference between the shortest Mahalanobis distance and the second-shortest Mahalanobis distance is equal to or below a prescribed value.

8. The signal processing method of claim 7, further comprising the steps of:
(c) outputting target information to a vehicle controller that controls a behavior of a vehicle, wherein
the step (c) delays an output timing of the target information to the vehicle controller compared to a standard output timing in a case where the validity is low.

9. The signal processing method of claim 8, wherein
in another case where the difference between the shortest Mahalanobis distance and the second-shortest Mahalanobis distance is above the prescribed value as for the target information of which the output timing is delayed, the step (c) outputs the target information to the vehicle controller.
